(19) United States
(12) Patent Application Publication
(10) Pub. No.: US 2022/0103583 A1
(43) Pub. Date: Mar. 31, 2022

(54) INFORMATION TRANSMISSION DEVICE, SERVER, AND INFORMATION TRANSMISSION METHOD

(71) Applicant: Panasonic Intellectual Property Management Co., Ltd., Osaka (JP)

(72) Inventors: Yuishi TORISAKI, Osaka (JP); Kaoru YOKOTA, Hyogo (JP); Takayuki FUJII, Osaka (JP); Akihito TAKEUCHI, Osaka (JP)

(73) Assignee: Panasonic Intellectual Property Management Co., Ltd., Osaka (JP)

(21) Appl. No.: 17/479,734

(22) Filed: Sep. 20, 2021

(30) Foreign Application Priority Data
Sep. 29, 2020 (JP) 2020-163044

(51) Int. Cl. H04L 29/06

(52) U.S. Cl. CPC H04L 63/1425; H04L 63/1441; H04L 63/1416

(57) ABSTRACT

An information transmission device is provided in an object that including one or more devices and a monitoring sensor monitoring each device. The information transmission device includes: an obtainer that obtains, from the monitoring sensor, first detection information indicating that an anomaly is detected in any device; and a transmitter that transmits, to an external device, monitoring information including the first detection information and relevance information. The relevance information indicates relevance between the first detection information and second detection information which is obtained from the monitoring sensor and transmitted from the transmitter to the external device prior to the transmission of the first detection information. The second detection information indicating that an anomaly is detected in any device, and relating to the first detection information.

### CROSS REFERENCE TO RELATED APPLICATION

The present application is based on and claims priority of Japanese Patent Application No. 2020-163044 filed on Sep. 29, 2020.

### FIELD

The present disclosure relates to an information transmission device, a server, and an information transmission method.

### BACKGROUND

In recent years, objects such as vehicles and electronic devices (for example, household electrical appliances) are being communicably connected to external devices through a communication network such as the Internet. By this means, an object can be controlled from an external device through the communication network, although on the other hand, the object is exposed to the threat of a cyberattack through the communication network. For example, if a vehicle receives a cyberattack, there is a risk that the vehicle may malfunction due to an unauthorized control command. Therefore, studies are being conducted with regard to performing monitoring and the like of the security status of an object based on the information of a sensor or the like provided in the object. PTL 1 discloses a security monitoring method for monitoring the security status of a plurality of objects with a small amount of communication traffic.

### CITATION LIST

### Patent Literature

PTL 1: Japanese Patent No. 5447394

### SUMMARY

In this connection, studies are being conducted with regard to servers performing analysis processing concerning the contents of a cyberattack or the effect on an object caused by a cyberattack and the like, based on information from the object. However, there is room for improvement in the analysis processing performed by servers.

Therefore, according to the present disclosure, provided are an information transmission device which can further improve the analysis processing performed by a server, the server, and an information transmission method.

In accordance with an aspect of the present disclosure, an information transmission device is provided in an object, the object including one or more devices and a monitoring sensor monitoring each of the one or more devices, and the information transmission device includes: an obtainer that obtains, from the monitoring sensor, first detection information indicating that an anomaly is detected in any one of the one or more devices; a transmitter that transmits, to an external device, monitoring information including (i) the first detection information and (ii) relevance information, the relevance information indicating relevance between the first detection information and second detection information which is obtained from the monitoring sensor and transmitted from the transmitter to the external device prior to the transmission of the first detection information, the second detection information indicating that an anomaly is detected in any one of the one or more devices, and relating to the first detection information.

In accordance with another aspect of the present disclosure, a server includes: a receiver that receives the first detection information from the information transmission device described above; and a controller that analyzes a cyberattack on the object in accordance with the first detection information and the second detection information, the second detection information being indicated in the relevance information included in the first detection information and being received by the receiver prior to the receiving of the first detection information.

In accordance with still another aspect of the present disclosure, an information transmission method for an object, the object including one or more devices and a monitoring sensor monitoring each of the one or more devices, includes: obtaining, from the monitoring sensor, first detection information indicating that an anomaly is detected in any one of the one or more devices; transmitting, to an external device, monitoring information including (i) the first detection information and (ii) relevance information, the relevance information indicating relevance between the first detection information and second detection information which is obtained from the monitoring sensor and transmitted from the transmitter to the external device prior to the transmission of the first detection information, the second detection information indicating that an anomaly is detected in any one of the one or more devices, and relating to the first detection information.

An information transmission device and the like according to one aspect to the present disclosure can further improve the analysis processing performed by a server.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating the functional configuration of a vehicle monitoring system according to an embodiment.

FIG. 2 is a block diagram illustrating the functional configuration of a transmission determination module according to the embodiment.

FIG. 3 is a flowchart illustrating basic operations of the transmission determination module according to the embodiment.

FIG. 4 is a view illustrating an example of anomaly detection by monitoring sensors.

FIG. 5 is a view illustrating an outline of vehicle monitoring log information generated based on alert A at time t1.

FIG. 6 is a view illustrating an outline of vehicle monitoring log information generated based on alert B at time t2.

FIG. 7 is a flowchart illustrating an example of a series of operations which the transmission determination module performs when the anomalies shown in FIG. 4 are detected.

FIG. 8 is a view illustrating an outline of vehicle monitoring log information which is transmitted in step S203 shown in FIG. 7.

FIG. 9 is a view illustrating an outline of vehicle monitoring log information which is transmitted in step S208 shown in FIG. 7.

FIG. 10 is a view illustrating an outline of vehicle monitoring log information which is transmitted in step S209 shown in FIG. 7.

FIG. 11 is a view illustrating an outline of vehicle monitoring log information which is transmitted in step S211 shown in FIG. 7.

FIG. 12 is a flowchart illustrating detailed operations of the transmission determination module according to the embodiment.

FIG. 13 is a view illustrating an example of transmission status information that is stored in a transmission status storage.

FIG. 14 is a view illustrating another example of transmission status information that is stored in the transmission status storage.

FIG. 15 is a flowchart illustrating operations of a monitoring system according to the embodiment.

FIG. 16 is a block diagram illustrating the functional configuration of a transmission determination module according to a comparative example.

FIG. 17 is a flowchart illustrating operations of the transmission determination module according to the comparative example.

### DESCRIPTION OF EMBODIMENT

(Circumstances which LED to Arriving at the Present Disclosure)

Before describing an embodiment of the present disclosure, the circumstances which led to arriving at the present disclosure will be described.

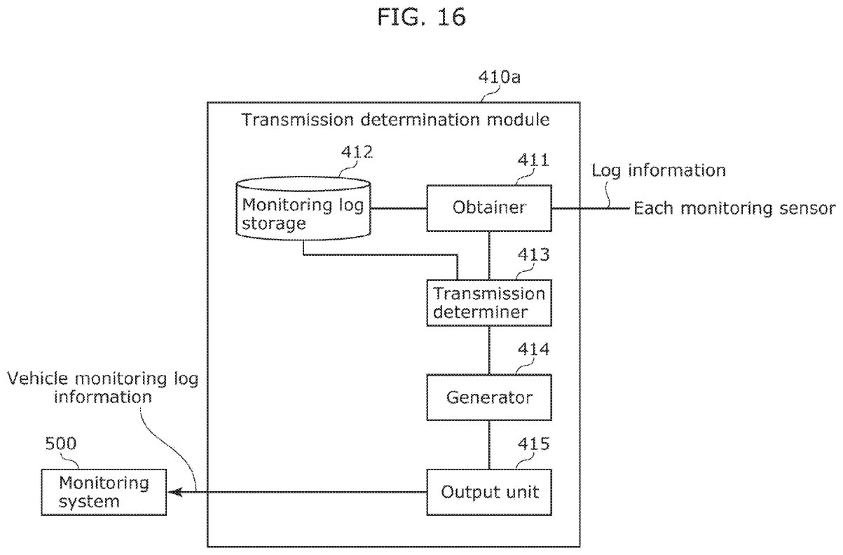

As has been described in the “Background Art” section, in recent years, studies are being conducted with regard to monitoring the security status of the object such as vehicles and electronic devices based on information from the object. For example, in a case where the object is a vehicle, studies are being conducted with regard to monitoring the security status (for example, the contents of a cyberattack, or the effect on the object caused by the cyberattack) of the vehicle by means of a server, based on anomaly detection results of respective monitoring sensors provided in the vehicle. In this case, in the vehicle, for example, a transmission determination module is provided that collects, from each monitoring sensor, log information including an anomaly detection result indicating that an anomaly of an in-vehicle device provided in the vehicle was detected, and transmits the log information to a server. A configuration assumed as the configuration of such kind of transmission determination module will now be described while referring to FIG. 16. FIG. 16 is a block diagram illustrating the functional configuration of transmission determination module 410a according to a comparative example.

As illustrated in FIG. 16, transmission determination module 410a has obtainer 411, monitoring log storage 412, transmission determiner 413, generator 414, and output unit 415.

Obtainer 411 obtains log information from each monitoring sensor provided in the vehicle. The log information is information including a monitoring result of an in-vehicle device by a monitoring sensor, and for example includes information indicating that the monitoring sensor detected an anomaly. The log information may include at least one kind of information among information identifying an in-vehicle device from which an anomaly was detected, information indicating the type of an anomaly, and information indicating the time of occurrence of an anomaly and the like.

Monitoring log storage 412 stores log information that obtainer 411 obtained.

Transmission determiner 413 determines whether or not to transmit log information stored in monitoring log storage 412 to monitoring system 500. For example, upon a predetermined number of items of log information being stored in monitoring log storage 412, transmission determiner 413 may determine to transmit a plurality of items of log information which are stored to monitoring system 500.

In a case where transmission determiner 413 makes a determination to transmit log information, generator 414 generates vehicle monitoring log information for transmitting a plurality of items of log information to monitoring system 500.

Output unit 415 transmits the vehicle monitoring log information which generator 414 generated to monitoring system 500.

Further, monitoring system 500 monitors the security status of the vehicle in which transmission determination module 410a is provided. Monitoring system 500 analyzes the security status of the vehicle based on the plurality of items of log information transmitted from transmission determination module 410a.

Here, the vehicle has a plurality of in-vehicle devices (for example, ECUs (electronic control units)), and a single in-vehicle network system is constituted by the plurality of in-vehicle devices. Therefore, a cyberattack (hereinafter, also described as simply an “attack”) on the vehicle is often carried out by attacks on the respective in-vehicle devices, that is, by a combination of a plurality of attacks. Therefore, in order to accurately ascertain the contents of an attack on a vehicle as well as the effect of the attack and the like, it is insufficient to analyze an attack on a single in-vehicle device, and there is a need to collectively analyze a plurality of attacks (for example, a plurality of attacks carried out in succession). That is, there is a need for monitoring system 500 to perform analytical processing with respect to a cyberattack on the vehicle by using a plurality of items of log information. It can also be said that there is a need for monitoring system 500 to perform analytical processing with respect to the cyberattack on the vehicle by regarding a plurality of attacks which are related to each other as a single attack. A plurality of attacks that can be regarded as a single attack is also described as a series of attacks. A series of attacks may be attacks carried out by the same attacker, may be attacks for achieving the same attack purpose, may be attacks carried out within a predetermined time period, or may be attacks carried out in a predetermined region (region on a map).

Transmission determiner 413, for example, in a case where a plurality of items of log information with respect to a series of attacks are stored in monitoring log storage 412, may transmit vehicle monitoring log information including the plurality of items of log information to monitoring system 500. By this means, at monitoring system 500, since a plurality of items of log information with respect to a series of attacks can be obtained at one time, analysis processing with respect to a cyberattack on the vehicle in which transmission determination module 410a is provided can be efficiently performed.

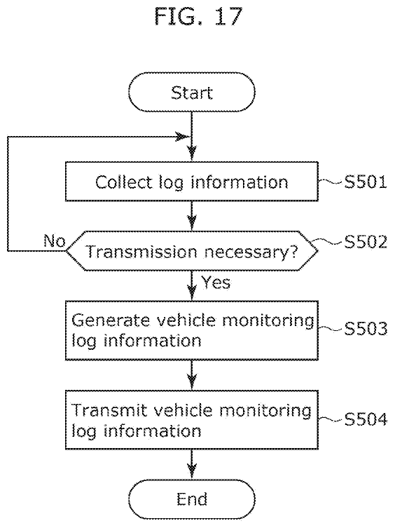

Next, operations which are assumed to be performed in transmission determination module 410a described above will be described while referring to FIG. 17. FIG. 17 is a flowchart illustrating operations of transmission determination module 410a according to the comparative example.

As illustrated in FIG. 17, obtainer 411 collects log information from each monitoring sensor (S501). Obtainer 411 stores the collected log information in monitoring log storage 412.

Next, transmission determiner 413 determines whether or not it is necessary to transmit the log information that was collected in step S501 to monitoring system 500 (S502). For example, transmission determiner 413 makes the determination in step S502 according to whether or not log information with respect to a series of attacks on the vehicle is stored in monitoring log storage 412.

Next, upon transmission determiner 413 determining that transmission is necessary (“Yes” in S502), generator 414 generates vehicle monitoring log information based on a plurality of items of log information (S503), and transmits the generated vehicle monitoring log information to monitoring system 500 (S504). Further, if transmission determiner 413 determines that transmission is not necessary (“No” in S502), obtainer 411 continues the collection of log information.

However, in the vehicle, a large storage area (memory capacity) is required in order to store (hold) a plurality of items of log information. On the other hand, the storage area of monitoring log storage 412 is sometimes subject to constraints. That is, in some cases monitoring log storage 412 does not have a storage area for storing a plurality of items of log information with respect to a series of attacks.

In such a case, it is assumed that the plurality of items of log information with respect to a series of attacks are transmitted separately from each other to monitoring system 500. Monitoring system 500 can determine which items among the items of log information which are received a plurality of times are items of log information with respect to a series of attacks, and can analyze the cyberattack on the vehicle using one or more items of log information which were determined as being items of log information with respect to a series of attacks.

However, because monitoring system 500 performs processing to determine whether or not the log information is log information with respect to a series of attacks, the processing load at monitoring system 500 increases. Since log information from a plurality of vehicles is transmitted to monitoring system 500, in a case where monitoring system 500 performs determination processing with respect to each of the vehicles, the processing load of monitoring system 500 can become a large load. Therefore, in a case where a plurality of items of log information with respect to a series of attacks are transmitted separately from each other to monitoring system 500, it is desirable to suppress an increase in the processing load at monitoring system 500.

Therefore, the inventors of the present application conducted diligent studies regarding an information transmission device and the like which, even in a case where a plurality of items of log information with respect to a series of attacks are transmitted separately from each other to monitoring system 500, can suppress an increase in the processing load at monitoring system 500, that is, can reduce the processing load at monitoring system 500, and invented the information transmission device and the like described hereunder.

In accordance with an aspect of the present disclosure, an information transmission device is provided in an object, the object including one or more devices and a monitoring sensor monitoring each of the one or more devices, and the information transmission device includes: an obtainer that obtains, from the monitoring sensor, first detection information indicating that an anomaly is detected in any one of the one or more devices; a transmitter that transmits, to an external device, monitoring information including (i) the first detection information and (ii) relevance information, the relevance information indicating relevance between the first detection information and second detection information which is obtained from the monitoring sensor and transmitted from the transmitter to the external device prior to the transmission of the first detection information, the second detection information indicating that an anomaly is detected in any one of the one or more devices, and relating to the first detection information.

Thus, by merely obtaining monitoring information, an external device (for example, a server) can obtain information indicating the relevance between first detection information, and second detection information which was already received. That is, in the external device which processes the first detection information and the second detection information, processing for determining the relevance between the first detection information and the second detection information need not be performed. Hence, the information transmission device can reduce the processing load of the external device.

For example, it is possible that the relevance information includes at least one of: information indicating that the second detection information is present; or information which is for identifying the second detection information and is included in the second detection information.

Thus, at the external device, at least one of processing for determining whether or not second detection information is present and processing for identifying second detection information from among a plurality of items of detection information can be omitted.

For example, it is also possible that the transmitter transmits the monitoring information when a predetermined condition is satisfied, the monitoring information further includes information indicating that the predetermined condition is satisfied.

Thus, the external device can obtain information indicating that a predetermined condition is satisfied, in other words, the reason why first detection information was transmitted. That is, the external device can execute processing in accordance with the reason with respect to the first detection information. Hence, since the information transmission device can cause processing to be performed efficiently at the external device, the information transmission device can further reduce the processing load of the external device.

For example, it is further possible that the information transmission device further includes: a storage that holds the first detection information, wherein the predetermined condition includes at least one of: a condition that a severity of the anomaly indicated in the first detection information is greater than or equal to a predetermined severity; a condition that a cyberattack causing the anomaly is determined to have ended; a condition that a predetermined time period has passed since the anomaly indicated in the first detection information is detected; or a condition that an available capacity of the storage is less than or equal to a predetermined capacity.

Thus, the external device can perform processing in accordance with any one of: a case where the severity of the anomaly indicated in the first detection information is greater than or equal to a predetermined severity; a case where a cyberattack that caused the anomaly is determined to have ended; a case where a predetermined time period has passed since the anomaly indicated in the first detection information is detected; and a case where an available capacity of the storage is less than or equal to a predetermined capacity. For example, in a case where the predetermined condition is that the severity of the anomaly indicated in the first detection information is greater than or equal to a predetermined severity, since there is a possibility that the object is being exposed to a threat, the external device can perform processing such as analysis in advance using only the first detection information and second detection information that was already obtained. Further, for example, in a case where the predetermined condition is that the available capacity of the storage is less than or equal to a predetermined capacity, since there is a possibility that further detection information will be obtained after the first detection information (the cyberattack is continuing), by waiting until the cyberattack is determined to have ended and then performing processing after the end of the cyberattack, the external device can collectively process a plurality of items of detection information with respect to a cyberattack in an efficient manner.

For example, it is still further possible that the predetermined condition further includes a condition that each of a severity of the anomaly indicated in the first detection information and a severity of the anomaly indicated in the second detection information is greater than or equal to the predetermined severity.

Thus, first detection information is transmitted depending on the severity of an anomaly as an object, based on first detection information and second detection information. For example, since first detection information is immediately transmitted in a case where the object is being exposed to a threat, it is possible to swiftly perform processing with respect to the first detection information at the external device.

For example, it is still further possible that the information transmission device further includes: a determiner that determines whether or not the second detection information is related to the first detection information, based on (i) respective times of obtaining the first detection information and the second detection information by the obtainer or (ii) a time sequential pattern regarding the anomalies indicated in the first detection information and the second detection information, the time sequential pattern being at least one of (ii-1) a time sequential pattern of devices from which the anomalies are detected among the one or more devices or (ii-2) a time sequential pattern of types of the anomalies.

Thus, the information transmission device can collectively perform the processing from obtainment of detection information until transmission of monitoring information corresponding to the detection information.

For example, it is still further possible that when the obtainer obtains the first detection information within a predetermined time period after the obtainer obtains the second detected information, or when the time sequential pattern regarding the anomalies indicated in the first detection information and the second detection information at least partially matches a predetermined time sequential pattern, the determiner determines that the second information is related to the first detection information.

Thus, the information transmission device can obtain information regarding the relevance between first detection information and second detection information merely by calculating a difference between the time of obtaining the first detection information and the time of obtaining the second detection information, or by comparing a time sequential pattern that is based on the first detection information and the second detection information and a predetermined time sequential pattern. That is, the processing load with respect to determination processing by the determiner can be reduced.

For example, it is still further possible that the determiner determines whether or not third detection information is related to the first detection information, the third detection information being obtained by the obtainer from the monitoring sensor prior to the obtaining of the first detection information, and not having yet been transmitted from the transmitter to the external device at a time of the obtaining of the first detection information, and the transmitter transmits the third detection information together with the first detection information to the external device, when the determiner determines that the third detection information is related to the first detection information and the second detection information.

Thus, third detection information which is related to first detection information and which has not yet been transmitted can be transmitted together with the first detection information. Since processing can also be performed using the third detection information at the external device, for example, an improvement in the analytical accuracy of the external device can be expected.

For example, it is still further possible that the object is a vehicle, and the one or more devices and the information transmission device are included in an in-vehicle network by connection via a communication path.

Thus, the information transmission device can be used in an in-vehicle network of a vehicle.

In accordance with another aspect of the present disclosure, a server includes: a receiver that receives the first detection information from the information transmission device described above; and a controller that analyzes a cyberattack on the object in accordance with the first detection information and the second detection information, the second detection information being indicated in the relevance information included in the first detection information and being received by the receiver prior to the receiving of the first detection information.

Thus, by merely obtaining monitoring information, a server can obtain information indicating the relevance between first detection information and second detection information which has already been received. That is, the server need not perform processing for determining the relevance between the first detection information and the second detection information. Hence, the processing load of the server is reduced.

In accordance with still another aspect of the present disclosure, an information transmission method for an object, the object including one or more devices and a monitoring sensor monitoring each of the one or more devices, includes: obtaining, from the monitoring sensor, first detection information indicating that an anomaly is detected in any one of the one or more devices; transmitting, to an external device, monitoring information including (i) the first detection information and (ii) relevance information, the relevance information indicating relevance between the first detection information and second detection information which is obtained from the monitoring sensor and transmitted from the transmitter to the external device prior to the transmission of the first detection information, the second detection information indicating that an anomaly is detected in any one of the one or more devices, and relating to the first detection information.

Thus, similar effects as the effects of the aforementioned information transmission device can be obtained.

These general and specific aspects may be implemented to a system, a method, an integrated circuit, a computer program, or a non-transitory computer-readable recording medium such as a Compact Disc-Read Only Memory (CD-ROM), or may be any combination of them. The program may be stored in the recording medium, or provided to the recording medium via a wide area network such as the Internet.

Hereinafter, certain exemplary embodiments will be described in detail with reference to the accompanying Drawings

The following embodiments are general or specific examples of the present disclosure. The numerical values, shapes, materials, elements, arrangement and connection configuration of the elements, steps, the order of the steps, etc., described in the following embodiments are merely examples, and are not intended to limit the present disclosure. Among elements in the following embodiments, those not described in any one of the independent claims indicating the broadest concept of the present disclosure are described as optional elements. It should be noted that the respective figures are schematic diagrams and are not necessarily precise illustrations. Additionally, components that are essentially the same share like reference signs in the figures.

It should also be noted that the following description may include numerical values and expressions using “the same” and “identical” to indicate relationships between the constituent elements. However, such numerical values and expressions do not mean exact meanings only. They also mean the substantially same ranges including a difference of, for example, about several % from the completely same range.

### Embodiment

Hereunder, a vehicle monitoring system including a transmission determination module according to the present embodiment is described while referring to the accompanying drawings.

[1. Configuration of Vehicle Monitoring System]

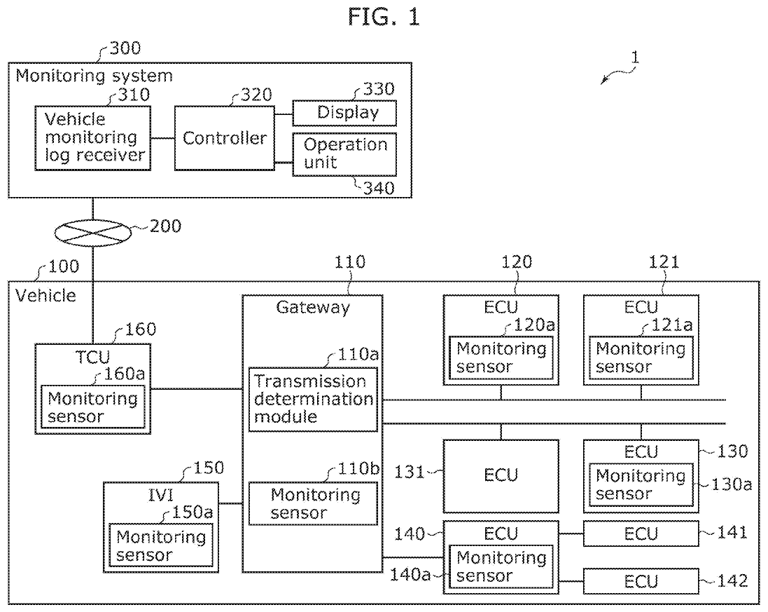

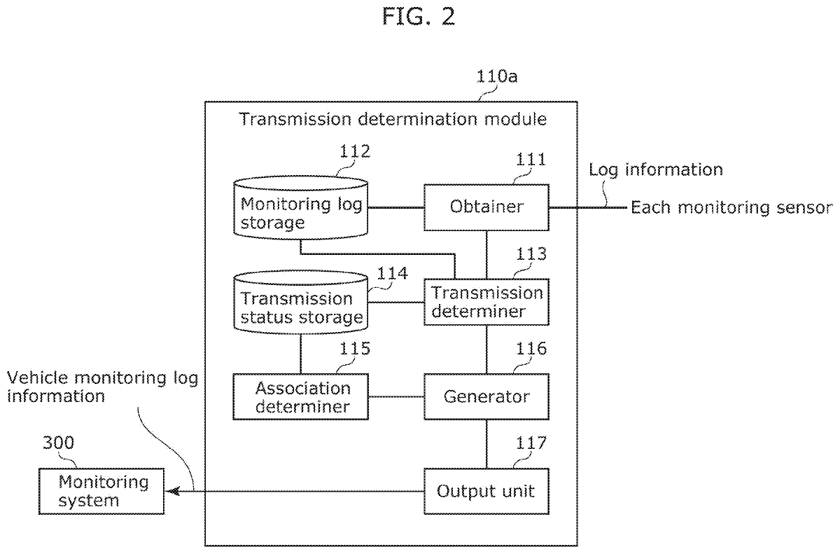

First, the configuration of vehicle monitoring system 1 according to the present embodiment is described while referring to FIG. 1 and FIG. 2. FIG. 1 is a block diagram illustrating the functional configuration of vehicle monitoring system 1 according to the present embodiment. Vehicle monitoring system 1 is an information processing system which performs analysis processing with respect to a cyberattack on vehicle 100 based on log information from vehicle 100.

As illustrated in FIG. 1, vehicle monitoring system 1 includes vehicle 100, communication network 200, and monitoring system 300. Note that, although one vehicle 100 is illustrated in FIG. 1, the number of vehicles 100 which vehicle monitoring system 1 includes is not particularly limited, and may be two or more.

Vehicle 100 has gateway 110, one or more ECUs 120, 121, 130, 131, 140, 141, and 142, IVI (in-vehicle infotainment) 150, and TCU (telematics control unit) 160. Hereinafter, when it is not necessary to differentiate between the one or more ECUs 120, 121, 130, 131, 140, 141, and 142, the term “ECUs 120 and the like” is also used to refer to the one or more ECUs 120, 121, 130, 131, 140, 141, and 142. Note that, gateway 110, ECUs 120 and the like, IVI 150, and TCU 160 are examples of devices (in-vehicle devices). Further, the number of devices which vehicle 100 includes is not particularly limited, and it suffices that the number is one or more.

Note that, the one or more ECUs 120 and the like are connected to each other by an in-vehicle network. Many communication standards (communication protocols) exist for in-vehicle networks, and a communication standard called “Controller Area Network” (hereinafter, referred to as “CAN” (registered trademark; the same applies hereunder)) is one of the most mainstream in-vehicle network standards among these communication standards. Although in the present embodiment it is assumed that the one or more ECUs 120 and the like are connected by CAN, the present disclosure is not limited thereto, and the one or more ECUs 120 and the like may be connected by CAN-FD (CAN with Flexible Data Rate), FlexRay (registered trademark), Ethernet (registered trademark) or the like. Further, the communication standards may differ for each bus.

Gateway 110 exchanges data such as log information with ECUs 120 and the like, IVI 150, and TCU 160. In the present embodiment, gateway 110 functions as a collection apparatus which collects log information from respective ECUs 120 and the like, IVI 150, and TCU 160. Further, gateway 110 may perform processing for transferring received data to another bus.

Gateway 110 is connected to each of the constituent elements of vehicle 100 through buses. Gateway 110, for example, is connected to ECUs 120 and 121 through a bus (first bus), is connected to ECU 130 and 131 through a bus (second bus), and is connected to ECU 140 through a bus (third bus). Further, gateway 110 is connected to IVI 150 through a bus (fourth bus), and is connected to TCU 160 through a bus (fifth bus). Furthermore, gateway 110 is connected to ECUs 141 and 142 through ECU 140. ECUs 141 and 142 are connected to ECU 140 through buses (sixth bus and seventh bus), respectively. Gateway 110, ECUs 120 and the like, IVI 150, and TCU 160 are connected to the constituted in-vehicle network through buses (communication paths), and transmit and receive data to and from one another.

Gateway 110 has transmission determination module 110a and monitoring sensor 110b.

Transmission determination module 110a is a processing unit that performs processing for transmitting log information obtained from the respective constituent elements of vehicle 100 (for example, each in-vehicle device) to monitoring system 300. As described later in detail, when an anomaly is detected in any one of the in-vehicle devices, transmission determination module 110a generates vehicle monitoring log information that indicates that an anomaly was detected, and transmits the generated vehicle monitoring log information to monitoring system 300. Note that, transmission determination module 110a is an example of an information transmission device.

Monitoring sensor 110b is a sensor that monitors gateway 110. Monitoring sensor 110b detects an anomaly in gateway 110.

ECUs 120 and the like are each one kind of computer, in which a desired function is realized by a computer program. ECUs 120 and the like are in-vehicle computers which vehicle 100 includes. ECUs 120 and the like include, for example, an ECU having an engine control function, an ECU having a handle control function, and an ECU having a brake control function.

Each of ECUs 120 and the like has, for example, a monitoring sensor that monitors the ECU. ECU 120 has monitoring sensor 120a, ECU 121 has monitoring sensor 121a, ECU 130 has monitoring sensor 130a, and ECU 140 has monitoring sensor 140a.

IVI 150 has a function that provides information and entertainment and the like to a user riding in vehicle 100. IVI 150 may have a navigation function, a location information service function, a multimedia playback function for music or moving images or the like, an audio communication function, a data communication function, an Internet connection function or the like. Further, IVI 150 may have an input device such as a keyboard or a mouse that accepts inputs from a user, and a display device such as a liquid crystal display for displaying data. Furthermore, IVI 150 may be a display device with a touch panel function that is capable of both accepting input of data and displaying data.

IVI 150, for example, conducts communication with ECUs 120 and the like through gateway 110. Further, IVI 150, for example, conducts communication with a device that is external to vehicle 100 through gateway 110 and TCU 160. Note that, IVI 150 may be directly connected to TCU 160 through a bus.

IVI 150 has monitoring sensor 150a that monitors IVI 150. Monitoring sensor 150a has a function that detects an anomaly in IVI 150.

TCU 160 is a communication device, and communicates with a device that is external to vehicle 100 by carrying out radio communication with the external device. In the present embodiment, TCU 160 communicates with monitoring system 300 by utilizing communication network 200.

TCU 160 has monitoring sensor 160a that monitors TCU 160. Monitoring sensor 160a has a function that detects an anomaly in TCU 160.

Monitoring sensors 120a and the like monitor the target in-vehicle devices. In a case where a signal which causes an anomalous operation in vehicle 100 is included in a control signal to an in-vehicle device, monitoring sensors 120a and the like may detect the anomaly, or may measure controlled objects which are controlled by the in-vehicle devices (for example, may measure the speed, acceleration, and steering angle) and detect an anomaly based on the measurement results. Upon detecting an anomaly, monitoring sensors 120a and the like output log information including information to the effect that an anomaly was detected to transmission determination module 110a. The log information which monitoring sensors 120a and the like output to transmission determination module 110a is an example of detection information (for example, first detection information or second detection information).

Monitoring sensors 120a and the like may be configured to include a sensor capable of measuring one or more items such as vibration, distortion, sound, temperature, humidity, acceleration, angular velocity, and steering angle, or to include a camera for image analysis. Further, monitoring sensors 120a and the like may be monitoring sensors that monitor communication data of the connected buses. Furthermore, monitoring sensors 120a and the like may be configured to include processing units capable of analyzing control signals to the in-vehicle devices. Note that, the number of monitoring sensors 120a and the like which vehicle 100 includes is not particularly limited, and it suffices that the number is one or more. Further, one of monitoring sensors 120a and the like may monitor a plurality of in-vehicle devices.

Communication network 200 is a network for enabling communication between vehicle 100 and monitoring system 300, and for example may be a wide area network such as the Internet, or may be a local area network (LAN). Further, communication network 200 may be a wired network or a wireless network, or may be a combination of a wired network and a wireless network. In the present embodiment, communication network 200 is a wireless network.

Monitoring system 300 is a system for monitoring vehicle 100, and is provided at a remote location that is different from the location of vehicle 100. For example, monitoring system 300 is installed in a monitoring center for performing monitoring of vehicle 100. Monitoring system 300 monitors vehicle 100 based on received vehicle monitoring log information. Specifically, monitoring system 300 performs analysis processing with respect to a cyberattack on vehicle 100, based on received vehicle monitoring log information.

The monitoring center may be a center which is managed by an SOC (Security Operation Center) that is an organization that monitors log information using monitoring system 300. Monitoring system 300 includes vehicle monitoring log receiver 310, controller 320, display 330, and operation unit 340.

Vehicle monitoring log receiver 310 is a communication interface for communicating with vehicle 100. Vehicle monitoring log receiver 310 receives vehicle monitoring log information from vehicle 100 through communication network 200. Vehicle monitoring log receiver 310, for example, receives a plurality of items of log information with respect to a series of attacks, which are received by dividing transmission and reception of the plurality of items of log information into multiple rounds of transmission and reception. Vehicle monitoring log receiver 310 is, for example, realized by an antenna and a radio communication circuit, although vehicle monitoring log receiver 310 is not limited thereto. Vehicle monitoring log receiver 310 is an example of a receiver.

Controller 320 is a processing unit that controls each constituent element that monitoring system 300 includes. Controller 320, for example, stores vehicle monitoring log information that vehicle monitoring log receiver 310 received in a storage (not illustrated). Further, controller 320 analyzes a cyberattack on vehicle 100 by analyzing log information included in vehicle monitoring log information. For example, in a case where a plurality of items of log information with respect to a series of attacks is transmitted from vehicle 100 by dividing transmission and reception of the plurality of items of log information into multiple rounds of transmission and reception, controller 320 analyzes the cyberattack on vehicle 100 by analyzing the plurality of items of log information together. It can also be said that, in a case where a plurality of items of vehicle monitoring log information are received, controller 320 analyzes a cyberattack on vehicle 100 by extracting and analyzing one or more items of log information that are relevant from among log information included in each of the plurality of items of vehicle monitoring log information. Further, it can also be said that controller 320, for example, performs analysis relating to a cyberattack on vehicle 100 based on log information (target log information) included in vehicle monitoring log information obtained at the current time, and preceding log information which is log information (preceding log information) indicated by relevance information included in the vehicle monitoring log information and which was received prior to the target log information. The relevance information is information indicating the relation between the target log information and the preceding log information.

Note that, controller 320 does not make a determination as to whether or not vehicle monitoring log information that relates to the vehicle monitoring log information that vehicle monitoring log receiver 310 received was already received. Further, hereinafter, analyzing of log information included in vehicle monitoring log information is also referred to simply as “analyzing log information”.

A server device may be realized by vehicle monitoring log receiver 310 and controller 320 in monitoring system 300.

Note that, the storage may store a control program and the like that controller 320 executes.

Display 330 displays results of analysis of a cyberattack on vehicle 100 to a monitoring person who monitors vehicle 100. Display 330, for example, is a monitor device such as a liquid crystal display or organic EL (electroluminescent) display. Note that, monitoring person monitors vehicle 100 from a remote location at which the monitoring person cannot directly monitor vehicle 100 that is travelling. The phrase “cannot directly monitor” means, for example, that the monitoring person cannot visually observe vehicle 100 with the naked eye. That is, the monitoring person remotely monitors vehicle 100 from a location that is different from the surroundings of vehicle 100. Further, in a case where vehicle 100 is a self-driving vehicle, the monitoring person may remotely operate vehicle 100.

Operation unit 340 accepts operations that are input by the monitoring person. Operation unit 340 is realized by a keyboard, a mouse, a push-button, a touch panel or the like. Further, operation unit 340 may have a configuration that accepts operations which are input by speech, gestures or the like of the monitoring person.

Here, the configuration of transmission determination module 110a will be described while referring to FIG. 2. FIG. 2 is a block diagram illustrating the functional configuration of transmission determination module 110a according to the present embodiment.

As illustrated in FIG. 2, transmission determination module 110a has obtainer 111, monitoring log storage 112, transmission determiner 113, transmission status storage 114, association determiner 115, generator 116, and output unit 117.

Obtainer 111 obtains log information from in-vehicle devices such as ECUs 120 and the like, IVI 150, and TCU 160. Specifically, obtainer 111 obtains log information from the respective monitoring sensors which the respective in-vehicle devices include. Obtainer 111 stores the obtained log information in monitoring log storage 112.

Monitoring log storage 112 stores log information which obtainer 111 obtained and log information obtained from monitoring sensor 110b. As also described above, in some cases, due to constraints on the storage area (constraints on the memory capacity), monitoring log storage 112 may not have a sufficient storage area for storing all of a plurality of items of log information with respect to a series of attacks. Monitoring log storage 112 is an example of a storage.

Transmission determiner 113 determines whether or not to transmit log information stored in monitoring log storage 112 to monitoring system 300. In the present embodiment, transmission determiner 113 determines whether or not to transmit a plurality of items of log information with respect to a series of attacks separately from each other.

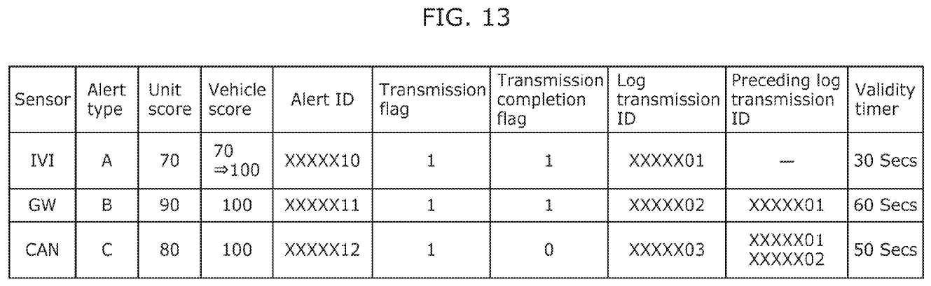

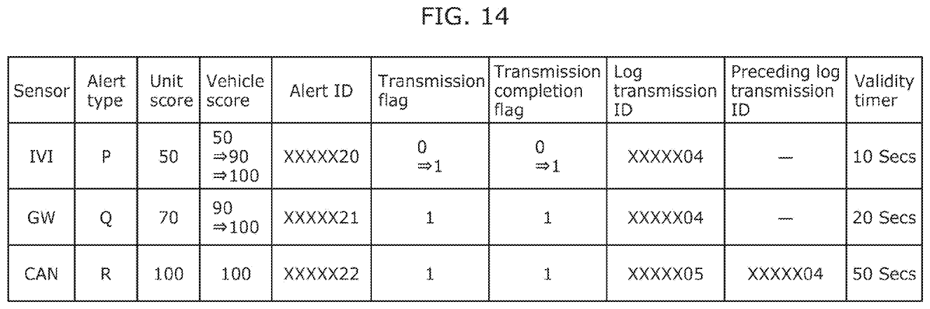

Transmission status storage 114 stores transmission status information with respect to log information, such as a result of a determination by transmission determiner 113 and a result of transmission by output unit 117. As described in detail later while referring to FIG. 13 and FIG. 14, the transmission status information is information in which a monitoring sensor, a type of anomaly (type of alert), a flag relating to transmission, an identifier (ID) relating to transmission, and the like are associated. The transmission status information, for example, is updated each time transmission determiner 113 makes a determination as to whether or not transmission is necessary, or each time output unit 117 transmits vehicle monitoring log information, although updating of the transmission status information is not limited thereto.

Based on log information which transmission determiner 113 determined is to be transmitted (target log information), and a history of already transmitted log information and which is log information indicating an anomaly that was detected prior to the target log information, association determiner 115 determines whether or not there is transmitted log information (preceding log information) that relates to the target log information. Association determiner 115, for example, determines whether or not there is preceding log information related to the target log information, based on the target log information and transmission status information. In a case where there is preceding log information related to the target log information, association determiner 115 associates the two items of log information. The preceding log information is log information which transmission determiner 113 determined was to be transmitted. Note that, the preceding log information is an example of second detection information.

Further, based on target log information, and a history of log information (untransmitted log information) which is log information indicating an anomaly that was detected prior to the target log information and which transmission determiner 113 determined was not necessary to transmit, association determiner 115 may determine whether or not there is untransmitted log information related to the target log information.

It suffices that association determiner 115 at least determines whether or not there is preceding log information. Association determiner 115 is an example of a determiner.

Generator 116 generates vehicle monitoring log information for transmitting to monitoring system 300 based on the log information (target log information) which transmission determiner 113 determined is to be transmitted and the result of the determination by association determiner 115 with respect to the log information. For example, in a case where there is transmitted log information which is related to the target log information, generator 116 generates vehicle monitoring log information that includes the target log information and information (relevance information) indicating the relation between the target log information and the transmitted log information.

Output unit 117 transmits vehicle monitoring log information which generator 116 generated, to monitoring system 300. Output unit 117 is an example of a transmitter.

Processing units such as obtainer 111, transmission determiner 113, association determiner 115, generator 116 and output unit 117 are realized, for example, by a control program stored in a storage (not illustrated) and a processor that executes the control program.

Monitoring log storage 112, transmission status storage 114 and the storage are realized, for example, by a ROM (Read Only Memory), a RAM (Random Access Memory), an HDD (Hard Disk Drive), an SSD (Solid State Drive) or the like.

As described above, transmission determination module 110a is a device which is provided in vehicle 100 having one or more in-vehicle devices (one example of a device) and monitoring sensors (for example, one or more monitoring sensors 120a and the like) monitoring each device, and which includes: obtainer 111 that obtains, from the monitoring sensor, first log information (one example of first detection information) indicating that an anomaly is detected in any one of the one or more in-vehicle devices; and output unit 117 (one example of a transmitter) that transmits, to monitoring system 300 (one example of an external device), in-vehicle monitoring log information (one example of monitoring information) that includes: the first log information, and relevance information indicating the relevance between the first log information and second log information (one example of second detection information) which indicates that an anomaly is detected in any one of the one or more in-vehicle devices which is obtained from a monitoring sensor and which relates to the first log information and is transmitted to monitoring system 300 prior to the transmission of the first log information.

Note that, the first log information and the second log information may be log information in a case where anomalies are detected in the same in-vehicle device, or may be log information in a case where anomalies are detected in-vehicle devices that are different to each other. Further, for example, the first log information and the second log information are transmitted to the same external device.

[2. Operations of Vehicle Monitoring System]

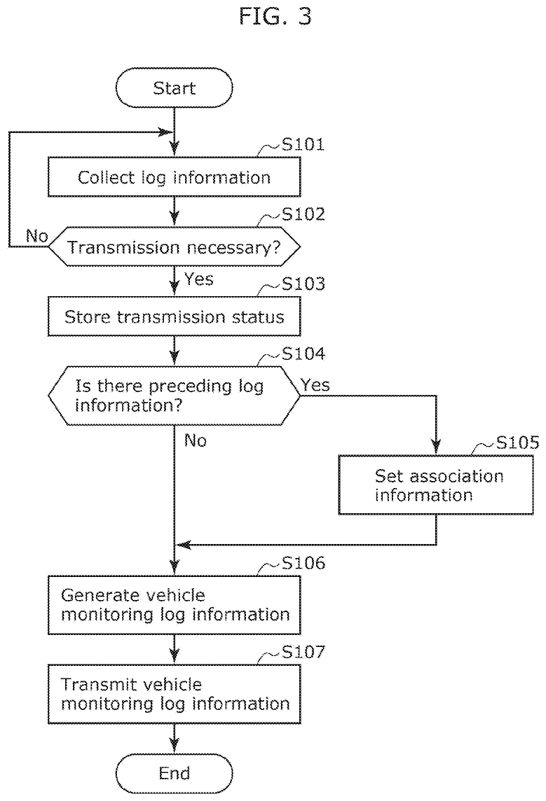

Next, operations of vehicle monitoring system 1 described above will be described while referring to FIG. 3 to FIG. 15.

[2-1. Operations of Transmission Determination Module]

First, basic operations of transmission determination module 110a will be described while referring to FIG. 3. FIG. 3 is a flowchart illustrating basic operations of transmission determination module 110a according to the present embodiment.

As illustrated in FIG. 3, obtainer 111 collects log information from monitoring sensors 120a and the like of the in-vehicle devices such as ECUs 120 and the like (S101). In other words, upon detecting an anomaly, monitoring sensors 120a and the like output log information indicating that an anomaly was detected to transmission determination module 110a. Obtainer 111 stores the obtained log information in monitoring log storage 112.

Next, transmission determiner 113 determines whether or not it is necessary to transmit the obtained log information to monitoring system 300 (S102). For example, in a case where the anomaly indicated by the log information is an anomaly for which the severity is high with respect to vehicle 100, transmission determiner 113 determines that it is necessary to transmit the log information. The phrase “severity is high”, for example, indicates that the severity with respect to the safety of vehicle 100 is greater than or equal to a predetermined severity, that is, the degree of risk is greater than or equal to a predetermined degree of risk. Transmission determiner 113 obtains the severity regarding the log information based on the type of anomaly (type of error) indicated by the log information, and a table in which types of anomalies and severities are associated, although a method for obtaining the severity is not limited thereto.

Further, transmission determiner 113 may determine whether or not to perform transmission based on the degree of matching in pattern matching between the log information and log information obtained further in the past than the log information, and an anomaly pattern showing at least one combination of a detection location of an anomaly and a type of anomaly. The anomaly pattern, for example, is at least one time sequential pattern of detection locations of anomalies and types of anomalies for determining whether or not a plurality of attacks is a series of attacks. The detection location of an anomaly shows an in-vehicle device in which the anomaly was detected. For example, in a case where anomalies were detected in a plurality of in-vehicle devices, the anomaly pattern includes the sequential order with respect to the in-vehicle devices in which the anomalies were detected, and the type of anomaly in each in-vehicle device in which an anomaly was detected.

Note that, the anomaly pattern is set in advance and is stored in the storage. The anomaly pattern may be determined based on time series data of detection locations of anomalies and types of anomalies when a series of attacks was received in the past, or may be determined based on a prediction of time series data of detection locations of anomalies and types of anomalies which are supposed for a time that an attack is received.

For example, in a case where the degree of matching is greater than or equal to a predetermined degree of matching, transmission determiner 113 may determine that log information is to be transmitted, and in a case where the degree of matching is less than the predetermined degree of matching, transmission determiner 113 may determine that log information is not to be transmitted since there is little or no related log information. By this means, in a case where the possibility that a series of attacks is being conducted is high, log information can be transmitted with priority to monitoring system 300.

Note that, for example, transmission determiner 113 may determine not to transmit log information in a case where the degree of matching is greater than or equal to a predetermined degree of matching, and may determine to transmit log information in a case where the degree of matching is less than the predetermined degree of matching. Further, transmission determiner 113 may determine to transmit log information in a case where the available capacity of monitoring log storage 112 is less than or equal to a predetermined capacity.

By this means, since at least some of a plurality of items of log information with respect to a series of attacks can be transmitted together, it leads to a reduction in communication traffic. In addition, since monitoring system 300 receives at least some log information among a plurality of items of log information with respect to a series of attacks together, monitoring system 300 can collectively perform processing with respect to the at least some log information.

Further, for example, in a case where a series of attacks ended, that is, a case where a cyberattack that caused an anomaly ended (for example, a case where transmission determiner 113 determined that a cyberattack has ended), transmission determiner 113 may determine that it is necessary to transmit log information. Transmission determiner 113 may determine whether or not a cyberattack has ended based on the log information and log information obtained further in the past than the log information, and an anomaly pattern. For example, transmission determiner 113 may determine that it is necessary to transmit log information in a case where an anomaly indicated by the log information matches an anomaly that occurs last in a predetermined anomaly pattern. Note that, a determination as to whether or not a series of attacks has ended is not limited to a determination that is made using an anomaly pattern, and may be a determination that is made by another method. Transmission determiner 113, for example, may determine that a series of attacks ended when a predetermined time period passes from a time at which log information was obtained.

Further, for example, in a case where a predetermined time period passes from a time at which log information was obtained (a case where a time-out occurred), transmission determiner 113 may determine that it is necessary to transmit the log information. The predetermined time period may be a common value, or may be a value that differs for each type of anomaly.

Further, for example, in a case where the available capacity of monitoring log storage 112 has become less than or equal to a predetermined capacity (for example, a case where monitoring log storage 112 reached a state in which the memory is full), transmission determiner 113 may determine that it is necessary to transmit log information.

At least one of a condition that the severity of the anomaly indicated in the log information is greater than or equal to a predetermined severity, a condition that a cyberattack that caused the anomaly has ended, a condition that a predetermined time period has passed since the anomaly indicated in the log information was detected, and a condition that the available capacity of monitoring log storage 112 is less than or equal to a predetermined capacity is an example of a predetermined condition for determining whether or not to transmit log information.

In a case where it is necessary to transmit log information (“Yes” in S102), transmission determiner 113 stores the transmission status of the log information in transmission status storage 114 (S103). For example, transmission determiner 113 associates the log information and information indicating that transmission is necessary (for example, a transmission flag “1”), and stores the associated information in transmission status storage 114. Further, when it is not necessary to transmit the log information (“No” in S102), transmission determiner 113 returns to step S101 and continues the processing.

Note that, in a case where the result of the determination in step S102 is “No”, transmission determiner 113 may associate the log information and information indicating that it is not necessary to transmit the log information (for example, a transmission flag “0”), and store the associated information in transmission status storage 114.

Next, association determiner 115 determines whether or not there is preceding log information with respect to the log information (target log information) which was determined as being necessary to transmit (S104). The preceding log information is log information which was obtained prior to the target log information and is related to the target log information, and is log information that was already transmitted (transmitted log information) to monitoring system 300. The term “is related to” means that the preceding log information and the target log information are a series of items of log information which were detected with respect to a series of attacks.

Association determiner 115, for example, determines whether or not the transmitted log information is related to the target log information based on the respective times of obtaining the target log information and the transmitted log information, or the degree of matching in a time sequential pattern regarding the devices from which the anomalies indicated in the target log information and the transmitted log information are detected and the types of the anomalies. Association determiner 115 determines that the transmitted log information is related to the target log information when the target log information was obtained within a predetermined time period after the transmitted log information was obtained, or when a time sequential anomaly pattern regarding the devices from which the anomalies indicated in the target log information and the transmitted log information are detected and the types of the anomalies at least partially matches a predetermined anomaly pattern. That is, association determiner 115 determines that there is preceding log information with respect to the target log information.

In a case where there is preceding log information (“Yes” in S104), association determiner 115 sets association information with respect to the target log information (S105). Association determiner 115 adds information relating to the preceding log information as log information that is related to the target log information, to the transmission status information which is being stored in transmission status storage 114. It suffices that the information relating to the preceding log information is information that can identify the log information (preceding log information) that is related to the target log information from among a plurality of items of log information which monitoring system 300 received. The information relating to the preceding log information, for example, is a log transmission ID used when the preceding log information was transmitted, although the information relating to the preceding log information may be the time at which the preceding log information was transmitted or the time at which an anomaly was detected. Further, association determiner 115 may enable identification of the relation between the presence of preceding log information and the target log information by, together with flag information indicating that preceding log information is present, using the log transmission ID that was used when the preceding log information was transmitted as the log transmission ID that is used when transmitting the target log information, or by adding a common attack determination ID which indicates that the logs are logs that relate to the same series of attacks.

Next, generator 116 generates vehicle monitoring log information including the log information which was determined as being necessary to transmit (S106). When the result determined in step S104 is “Yes”, association information (relevance information) is included in the vehicle monitoring log information.

Next, output unit 117 transmits the vehicle monitoring log information that generator 116 generated to monitoring system 300 (S107). Note that, when the result determined in step S102 is “No”, vehicle monitoring log information is not transmitted. That is, output unit 117 transmits vehicle monitoring log information including target log information to monitoring system 300 in a case where a predetermined condition is satisfied.

Note that, although it is described that the determination processing in step S104 determines whether or not the preceding log information and the target log information are a series of items of log information which were detected with respect to a series of attacks, the determination processing in step S104 may determine only whether or not preceding log information is present, and need not determine whether or not the preceding log information and the target log information are items of log information which were detected with respect to a series of attacks. In this case, if preceding log information is present, the target log information is regarded as being related to the preceding log information. Further, the determination processing in step S104 may be performed by another device other than transmission determination module 110a, and transmission determination module 110a may obtain the determination result of the other device. Note that, for example, monitoring system 300 is not included in the other device. Further, in step S102 and/or step S104, a determination as to whether or not the target log information and log information received prior to the target log information are a series of items of log information that were detected with respect to a series of attacks may be performed by another device other than transmission determination module 110a, and transmission determination module 110a may obtain the determination result of the other device.

Next, operations in a case where anomalies are detected in succession by two monitoring sensors will be described while referring to FIG. 4 to FIG. 11. FIG. 4 is a view illustrating an example of anomaly detection by monitoring sensors. Alerts A and B are examples of log information.

In FIG. 4, an example is illustrated in which anomalies are detected in succession at two monitoring sensors, namely, monitoring sensors A and B. Specifically, an anomaly (alert A) is detected by monitoring sensor A at time t1, and an anomaly (alert B) is detected by monitoring sensor B at time t2 that is later than time t1. Note that, although an example in which monitoring sensors A and B are different monitoring sensors to each other is illustrated in FIG. 4, monitoring sensors A and B may be the same monitoring sensor. Note that, it is assumed that alert A with respect to monitoring sensor A and alert B with respect to monitoring sensor B are caused by a series of attacks.

Here, it is assumed that at time t1, among monitoring sensors A and B, an anomaly is detected only by monitoring sensor A. In this case, obtainer 111 of transmission determination module 110a obtains log information including alert A from monitoring sensor A. Subsequently, in step S102, if it is determined that transmission is necessary, generator 116 generates the vehicle monitoring log information shown in FIG. 5. FIG. 5 is a view showing an outline of vehicle monitoring log information that is generated based on alert A at time t1.

As illustrated in FIG. 5, information relating to a log transmission ID, an alert type, preceding log existence, a preceding log transmission ID, a severity level, whether an attack ended, a time-out, and whether a memory is full is included in the vehicle monitoring log information (log A transmission contents) corresponding to alert A. An item relating to the time at which alert A was detected may be included in the vehicle monitoring log information.

The log transmission ID is identification information that is attached when transmitting the log information that includes alert A.

The alert type shows the type of anomaly detected by monitoring sensor A. In FIG. 5, an example in which an anomaly corresponding to alert A was detected by monitoring sensor A is illustrated.

The preceding log existence item shows whether or not there is preceding log information that relates to the log information corresponding to alert A. In the example in FIG. 5, it is shown that there is no preceding log information.

In a case where there is preceding log information, the log transmission ID that was attached when transmitting the preceding log information is set as the preceding log transmission ID. The preceding log transmission ID is information for identifying the preceding log information, and is information which is included in the preceding log information. In the example in FIG. 5, since there is no preceding log information, a preceding log transmission ID is not set.

The severity level item is information indicating whether or not the severity is high. In the example in FIG. 5, it is shown that the severity is high.

The attack ended item shows whether or not a series of attacks which caused the anomaly indicated by alert A is determined to have ended. In the example in FIG. 5, it is shown that the attacks are continuing.

The time-out item shows whether or not the elapsed time since alert A was detected has exceeded a predetermined time period. In the example in FIG. 5, it is shown that a time-out has not occurred.

The memory full item shows whether or not the available capacity of monitoring log storage 112 is less than or equal to a predetermined capacity. In the example in FIG. 5, it is shown that the memory of monitoring log storage 112 is not full.

Note that, it can also be said that the severity, attack ended, time-out, and memory full items are information showing the reason for determining that it was necessary to transmit alert A. In FIG. 5, an example is illustrated in which, because the severity of alert A is high, it was determined by the transmission determiner to transmit alert A individually. That is, it is shown that because the degree of risk of alert A is high and the degree of urgency is high, the vehicle monitoring log information was transmitted. Thus, information indicating the reason for determining that it was necessary to transmit target log information is included in the vehicle monitoring log information. It can also be said that information indicating that a predetermined condition for determining that transmission is necessary is satisfied is included in the vehicle monitoring log information.

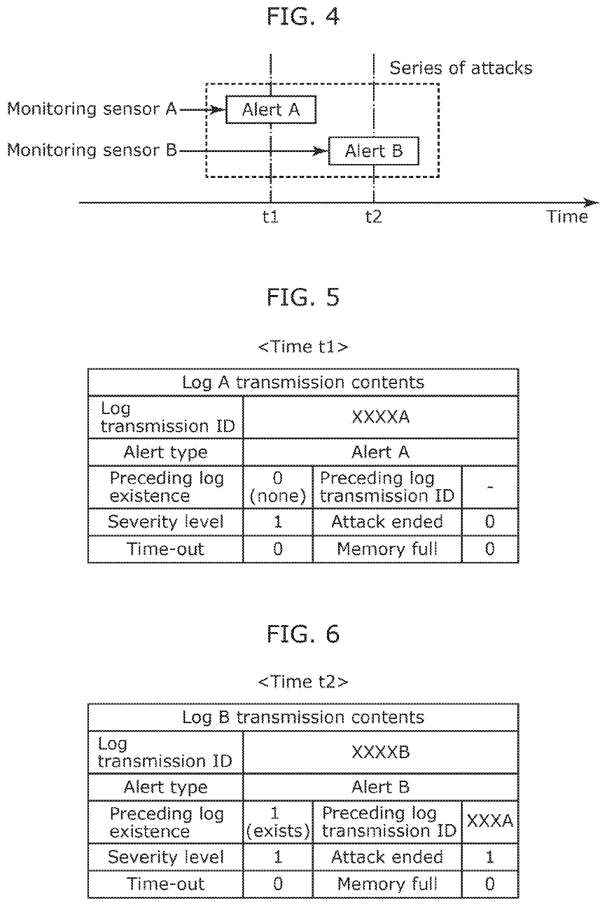

Next, vehicle monitoring log information (log B transmission contents) generated based on alert B at time t2 will be described while referring to FIG. 6. FIG. 6 is a view illustrating an outline of vehicle monitoring log information that is generated based on alert B at time t2. Note that, the items in the vehicle monitoring log information are the same as in FIG. 5.

As illustrated in FIG. 6, in the item for log transmission ID, an ID is set that is different from the log transmission ID of the vehicle monitoring log information that was transmitted at time t1. That is, the alerts A and B are each identifiable by the respective log transmission IDs. Note that, the log transmission ID that is set is not particularly limited.

In a case where preceding log information is present, “1” that indicates that preceding log information is present is set for the preceding log existence item, and the log transmission ID of the vehicle monitoring log information corresponding to alert A which was already transmitted is set for the preceding log transmission ID.

By this means, for example, by merely checking the information of the preceding log transmission ID of the vehicle monitoring log information corresponding to alert B, monitoring system 300 can know that the vehicle monitoring log information is related to the vehicle monitoring log information corresponding to alert A which was already received.

Note that, in a case where the transmission ID of alert A is set as the preceding log transmission ID, alert A is not included in the alert type.

Note that, the preceding log existence item and the preceding log transmission ID are examples of relevance information indicating the relevance between two items of log information. It can also be said that the preceding log existence item and the preceding log transmission ID are information indicating the correlation between two items of log information. Further, it suffices that at least one of the preceding log existence item and the preceding log transmission ID is included in the vehicle monitoring log information. That is, it suffices that the relevance information includes at least one of information indicating whether preceding log information is present, and information which is for identifying preceding log information and which is included in the preceding log information. By the preceding log existence item being included in the vehicle monitoring log information, processing by monitoring system 300 for determining whether or not there is preceding log information can be omitted. Further, by the preceding log transmission ID being included in the vehicle monitoring log information, processing by monitoring system 300 for extracting preceding log information can be omitted. From the viewpoint of further reducing the processing load of monitoring system 300, it is better for the preceding log transmission ID to be included in the vehicle monitoring log information. Note that, the processing load of monitoring system 300 may be reduced by adding, to the vehicle monitoring log information, information indicating whether there is preceding log information, and a common attack determination ID indicating that the logs relate to the same series of attacks. For example, in step S105, association determiner 115 may set, as association information, the same attack determination ID (common attack determination ID) for items of log information which were determined as being related to a series of attacks. In this case, by merely determining whether or not attack determination IDs match, monitoring system 300 can extract log information that relates to the target log information from among log information that was already obtained.

Note that, information relating to severity, whether an attack ended, a time-out and whether the memory is full need not be included in the vehicle monitoring log information.

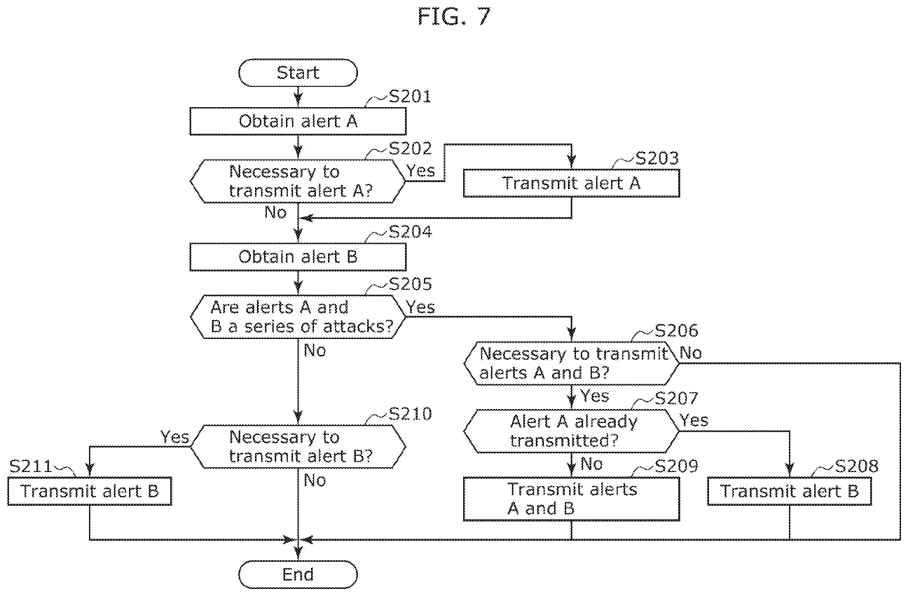

FIG. 7 is a flowchart illustrating a series of operations that transmission determination module 110a performs when an anomaly illustrated in FIG. 4 is detected. Note that, it is assumed that an alert that is related to alert A was not detected prior to time t1. That is, it is assumed that alert A is an alert regarding an anomaly that was detected first with respect to a series of attacks.

Obtainer 111 obtains alert A indicating that an anomaly was detected at time t1 (S201). Step S201 corresponds to step S101 shown in FIG. 3.

Next, transmission determiner 113 determines whether or not it is necessary to transmit alert A (S202).

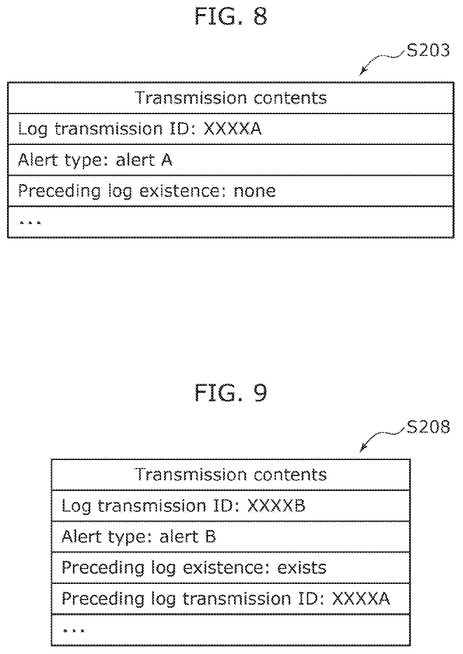

Next, if it is necessary to transmit alert A (“Yes” in S202), output unit 117 transmits vehicle monitoring log information including alert A generated by generator 116 to monitoring system 300. That is, output unit 117 transmits alert A (S203). Further, if it is not necessary to transmit alert A (“No” in S202), output unit 117 does not perform transmission of the vehicle monitoring log information including alert A. Step S202 corresponds to S102 shown in FIG. 3, and step S203 corresponds to S107 shown in FIG. 3. FIG. 8 is a view illustrating an outline of vehicle monitoring log information that is transmitted in step S203 shown in FIG. 7. Note that, in FIG. 8 to FIG. 11, some items from among the respective items included in the vehicle monitoring log information are extracted and illustrated.

As illustrated in FIG. 8, information indicating that the log transmission ID is “XXXXA”, the alert type is “alert A”, and that the entry for the preceding log existence item is “none” is included in the vehicle monitoring log information transmitted in step S203.

Referring again to FIG. 7, next, obtainer 111 obtains alert B that indicates an anomaly was detected at time t2 (S204). Step S204 corresponds to step S101 shown in FIG. 3.

Next, transmission determiner 113 determines whether or not alerts A and B are caused by a series of attacks (S205). The determination in step S205 corresponds to determining whether or not alerts A and B are related. If alerts A and B are caused by a series of attacks (“Yes” in S205), transmission determiner 113 determines whether or not it is necessary to transmit alerts A and B (S206). Transmission determiner 113 may make the determination in step S206 based on the severity in a case where alerts A and B are regarded as a single alert. The severity may be, for example, the severity in the case where alert B occurred after alert A, or may be a severity calculated by carrying out a predetermined arithmetic operation (for example, weighted addition) on the severity of alert A and the severity of alert B.

Next, if it is necessary to transmit alerts A and B (“Yes” in S206), transmission determiner 113 further determines whether or not alert A was transmitted (S207). Transmission determiner 113 determines whether or not alert A was transmitted, for example, based on transmission status information (for example, a transmission completion flag illustrated in FIG. 13) that is stored in transmission status storage 114.

Next, if alert A was transmitted, (“Yes” in S207), output unit 117 transmits vehicle monitoring log information including alert B that generator 116 generated to monitoring system 300. That is, output unit 117 transmits alert B (S208).

FIG. 9 is a view illustrating an outline of vehicle monitoring log information that is transmitted in step S208 shown in FIG. 7.

As illustrated in FIG. 9, information indicating that the log transmission ID is “XXXXB”, the alert type is “alert B”, the entry for the preceding log existence item is “exists”, and the preceding log transmission ID is “XXXXA” is included in the vehicle monitoring log information transmitted in step S208. That is, information indicating that the preceding log information for alert B is alert A that was transmitted in step S203 is included.

Referring again to FIG. 7, if alert A was not yet transmitted (“No” in S207), output unit 117 transmits vehicle monitoring log information including alerts A and B that generator 116 generated to monitoring system 300. That is, output unit 117 transmits alerts A and B (S209).

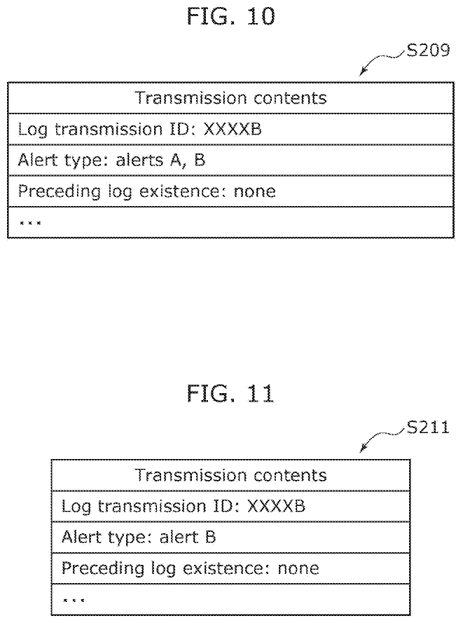

FIG. 10 is a view illustrating an outline of the vehicle monitoring log information transmitted in step S209 shown in FIG. 7.

As illustrated in FIG. 10, information indicating that the log transmission ID is “XXXXB”, the alert types are “alerts A, B”, and the entry for the preceding log existence item is “none” is included in the vehicle monitoring log information transmitted in step S209. That is, in step S209, both alert A and alert B are transmitted. Further, since alert A and alert B are transmitted at the same timing, a common log transmission ID is set.

Referring again to FIG. 7, if it is not necessary to transmit alerts A and B (“No” in S206), transmission determiner 113 ends the processing.

Further, if alerts A and B are not alerts caused by a series of attacks (“No” in S205), transmission determiner 113 determines whether or not it is necessary to transmit alert B (S210).

Next, if it is necessary to transmit alert B (“Yes” in S210), output unit 117 transmits vehicle monitoring log information including alert B that generator 116 generated to monitoring system 300. That is, output unit 117 transmits alert B (S211).

FIG. 11 is a view illustrating an outline of the vehicle monitoring log information transmitted in step S211 shown in FIG. 7.

As illustrated in FIG. 11, information indicating that the log transmission ID is “XXXXB”, the alert type is “alert B”, and that the entry for the preceding log existence item is “none” is included in the vehicle monitoring log information transmitted in step S211. That is, in step S211, vehicle monitoring log information including information indicating that there is no related log information is transmitted.

Referring again to FIG. 7, if it is not necessary to transmit alert B (“No” in S210), transmission determiner 113 ends the processing.

Note that, step S205 corresponds to step S104 shown in FIG. 3, steps S206 and S210 correspond to step S102 shown in FIG. 3, and steps S208, S209, and S211 correspond to step S107 shown in FIG. 3.

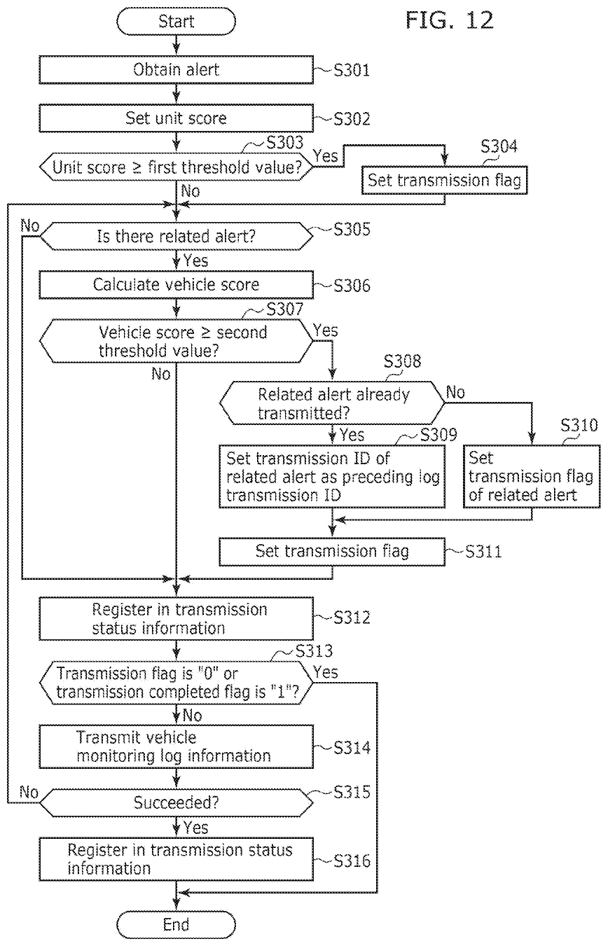

Next, detailed operations of transmission determination module 110a will be described while referring to FIG. 12. FIG. 12 is a flowchart illustrating detailed operations of transmission determination module 110a according to the present embodiment. In FIG. 12, the detailed operations are described using transmission status information that is stored in transmission status storage 114. Note that, in FIG. 12, an example of determining whether or not to transmit an alert using a vehicle score and a unit score as an example of severity is described.

As illustrated in FIG. 12, obtainer 111 obtains an alert (target alert) (S301). Step S301 corresponds to step S101 shown in FIG. 3.

Next, transmission determiner 113 sets a unit score (S302). The unit score shows the level of a threat (for example, a threat to the safety of vehicle 100) according to the alert. The higher the level of the threat is, for example, the higher the severity is, the higher the value is set for the unit score. The unit score, for example, is a numerical value within the range of 0 to 100, although the unit score is not limited thereto. Transmission determiner 113 may set a unit score with respect to the alert obtained in step S301, for example, based on a table in which unit scores are associated with detection locations of alerts and types of alerts.

Next, transmission determiner 113 determines whether or not the unit score is greater than or equal to a first threshold value (S303). In step S303, it is determined whether or not it is necessary to transmit the alert (target alert) obtained in step S301. The first threshold value, for example, is set in advance and stored in the storage.

Next, if the unit score is greater than or equal to the first threshold value (“Yes” in S303), transmission determiner 113 sets a transmission flag (S304). That is, when the result determined in step S303 is “Yes”, transmission determiner 113 sets the transmission flag to “1”. A “Yes” result in the determination in step S303 corresponds to determining that transmission is necessary.

Here, transmission status information that is stored in transmission status storage 114 will be described while referring to FIG. 13. FIG. 13 is a view illustrating one example of transmission status information that is stored in transmission status storage 114.

As illustrated in FIG. 13, the transmission status information includes items for sensor, alert type, unit score, vehicle score, alert ID, transmission flag, transmission completion flag, log transmission ID, preceding log transmission ID, and validity timer. Note that, information with respect to detection of anomalies by three monitoring sensors is included in the transmission status information illustrated in FIG. 13 and FIG. 14, and it is assumed that the anomalies were detected in the order from the first row to the third row, and the three anomalies are caused by a series of attacks. Further, information indicating the time at which an anomaly was detected may be included in the transmission status information.

“Sensor” shows which in-vehicle device the monitoring sensor that detected the anomaly is arranged in, that is, which in-vehicle device the anomaly was detected in. It can also be said that “sensor” shows the detection location at which the anomaly was detected. For example, the first row shows that monitoring sensor 150a of IVI 150 detected an anomaly.

“Alert type” shows the type of anomaly that the monitoring sensor detected.

“Unit score” is a numerical value indicating the threat according to the alert, and is a numerical value that is set in step S302.

“Alert ID” is identification information that identifies the alert.

“Transmission flag” shows the result of the determination with respect to whether or not transmission is necessary. A transmission flag of “1” indicates that transmission is necessary, while a transmission flag of “0” indicates that transmission is not necessary.

“Transmission completion flag” shows a transmission result with respect to whether or not the alert was transmitted to monitoring system 300. A transmission completion flag of “1” indicates that the alert was transmitted, while a transmission completion flag of “0” indicates that the alert was not yet transmitted.

For example, since the transmission flag and the transmission completion flag are both “1” for the alerts of IVI 150 and gateway 110 (GW), it indicates that transmission is necessary and that the alerts have been transmitted. Further, for example, for the alert of the CAN (for example, any one of the ECUs), since the transmission flag is “1” and the transmission completion flag is “0”, it indicates that transmission is necessary and that the alert was not yet transmitted.

“Preceding log transmission ID” shows the log transmission ID of related preceding log information. For example, the example in FIG. 13 shows that the alert of gateway 110 is related to the alert of IVI 150, and for example, the alert of the CAN is related to the alerts of IVI 150 and GW 110.

“Validity timer” shows a time period for determining that an alert relates to a series of attacks. For example, since the validity timer is set to 30 seconds for IVI 150, if an alert is further detected in any one of the elements of the respective in-vehicle devices of vehicle 100 within 30 seconds after the alert of alert type A is detected in IVI 150, it is determined that the alert is related to alert A of IVI 150.

If the result determined in step S303 is “Yes”, transmission determiner 113 updates the transmission flag with respect to the alert from “0” to “1”.

Referring again to FIG. 12, if the unit score is less than the first threshold value (“No” in S303), or after the processing in step S304, association determiner 115 determines whether or not there is a related alert (S305). A related alert is an alert that is related to the target alert.

Next, if there is a related alert (“Yes” in S305), transmission determiner 113 calculates a vehicle score (S306). The vehicle score indicates the level of the overall threat to vehicle 100 including the target alert and the related alert. The higher that the level of the threat is, for example, the higher the severity is, the higher the value that is set for the vehicle score. The vehicle score, for example, is a numerical value within the range of 0 to 100, although the vehicle score is not limited thereto. Transmission determiner 113 calculates the vehicle score, for example, using a table in which circumstances of the target alert and related alert (for example, alert detection location, time series data regarding the alert type, and the like) and vehicle scores are associated, although calculation of the vehicle score is not limited thereto.

Next, transmission determiner 113 determines whether or not the vehicle score is greater than or equal to a second threshold value (S307). The second threshold value may be the same value as the first threshold value, or may be a different value. For example, the second threshold value may be a larger value than the first threshold value.

Next, if the vehicle score is greater than or equal to the second threshold value (“Yes” in S307), transmission determiner 113 determines whether or not the related alert was transmitted (S308). Transmission determiner 113 performs the determination in step S308 based on whether the transmission completion flag of the related alert is “1” or is “0” in the transmission status information illustrated in FIG. 13.

If the transmission completion flag of the related alert is “1”, that is, if the related alert was transmitted (“Yes” in S308), transmission determiner 113 sets the log transmission ID of the related alert as the preceding log transmission ID of the target alert (S309). Further, if the transmission completion flag of the related alert is “0”, that is, if the related alert was not yet transmitted (“No” in S308), transmission determiner 113 sets the transmission flag of the related alert (S310). That is, when the result determined in step S308 is “No”, transmission determiner 113 updates the transmission flag of the related alert from “0” to “1”. Note that, in a case where the transmission completion flag of the related alert is “0” and the transmission flag is “1”, step S310 may be omitted.

Next, transmission determiner 113 sets the transmission flag of the target alert (S311). That is, transmission determiner 113 sets the transmission flag of the target alert to “1”.

Further, when there is no related alert (“No” in S305), or when the vehicle score is less than the second threshold value (“No” in S307), or after the processing in step S311, transmission determiner 113 registers the target alert in the transmission status information (S312). That is, transmission determiner 113 adds the information of the target alert including the flags which were set in the processing up to step S311, to the transmission status information.

Next, transmission determiner 113 determines whether or not the current situation is that the transmission flag of the target alert is “0” or transmission completion flag of the target alert is “1” (S313). If the transmission flag of the target alert is “1” or transmission completion flag of the target alert is “0” (“No” in S313), transmission determiner 113 transmits the vehicle monitoring log information including the target alert to monitoring system 300 (S314). A case where “No” is determined in step S313 is, for example, a case where the transmission flag of the target alert is “1” and the transmission completion flag of the target alert is “0”.

Here, for example, in a case where there is a related alert that was transmitted, the log transmission ID of the related alert is set as the preceding log transmission ID in the vehicle monitoring log information, in a case where there is a related alert that was not yet transmitted, the related alert is included in the vehicle monitoring log information, and in a case where there is no related alert, information indicating that there is no related alert is included in the vehicle monitoring log information. Note that, in a case where there is a related alert that was transmitted, information (preceding log existence) indicating that there is a related alert may be included in the vehicle monitoring log information.

Next, if transmission of the vehicle monitoring log information is successful (“Yes” in S315), transmission determiner 113 registers the vehicle monitoring log information in the transmission status information illustrated in FIG. 13 (S316). That is, transmission determiner 113 updates the transmission completion flag(s) in the transmission status information from “0” to “1”. In a case where there is a related alert which had not yet been transmitted, transmission determiner 113 updates the transmission completion flag of the related alert which had not yet been transmitted and the transmission completion flag of the target alert from “0” to “1”, and in cases other than this transmission determiner 113 updates the transmission completion flag of the target alert from “0” to “1”. Further, if transmission of the vehicle monitoring log information failed (“No” in S315), transmission determiner 113 returns to step S305 and continues the processing. Note that, it is possible to obtain information regarding whether or not transmission was successful, for example, by means of a reply from monitoring system 300.

In a case where the transmission flag of the target alert is “0” or the transmission completion flag of the target alert is “1” (“Yes” in S313), or after the processing in step S316, transmission determiner 113 ends the processing.

Here, FIG. 13 and FIG. 14 will be described.

FIG. 13 illustrates transmission status information at a time when alert A was detected in IVI 150, and after the alert A was transmitted to monitoring system 300, alert B was detected in gateway 110 (GW), and in addition, after the alert B was transmitted to monitoring system 300, alert C was detected in the CAN. Note that, since the transmission completion flag with respect to alert C is “0”, alert C has not yet been transmitted. It is assumed that the first threshold value and the second threshold value, for example, are each 70.

The vehicle score of alert A is updated from 70 to 100. The unit score of alert A is 70, and at that time the vehicle score was 70. Further, the unit score of alert B is 90. Because alert B was detected, and alert B is related to alert A, the vehicle score of alert B is updated to the score at the time of alerts A and B. In the example in FIG. 13, the vehicle score at the time of alerts A and B is higher than the respective unit scores of alerts A and B, and for example is 100. Therefore, after alert B is detected, the vehicle score with respect to alert A is also updated to 100 that is the vehicle score of alerts A and B. Note that, a history showing that the vehicle score is updated from 70 to 100 need not be stored in the transmission status information. Although FIG. 13 shows that the vehicle score was changed from 70 to 100 in order to show changes over time in the vehicle score, it suffices to store only the vehicle score after the change in the transmission status information.

Further, the preceding log transmission ID of alert B is the log transmission ID of alert A. By receiving alert B, monitoring system 300 can recognize that alert B is related to alert A. Further, the preceding log transmission IDs of alert C are the log transmission IDs of alerts A and B. By receiving alert C, monitoring system 300 can recognize that alert C is related to alerts A and B. Thus, by receiving alert C, monitoring system 300 knows that alerts A to C are alerts with respect to a series of attacks, and hence monitoring system 300 can analyze the cyberattack on vehicle 100 based on alerts A to C, without determining whether or not alerts A to C are alerts with respect to a series of attacks.

FIG. 14 is a view illustrating another example of transmission status information that is stored in transmission status storage 114.

FIG. 14 shows transmission status information in a state where alert P was detected in IVI 150, and after it was determined that it was not necessary transmit the alert P, alert Q was detected in gateway 110, and in addition, after the alerts P and Q were transmitted to monitoring system 300, alert R was detected in the CAN and the alert R was transmitted to monitoring system 300. It is assumed that the first threshold value and the second threshold value are each, for example, 80.

Since the unit score of alert P is 50 (<first threshold value), the result of the determination in each of steps S303 and S307 with respect to alert P alone is “No”. That is, in a state where only alert P has been obtained among alerts P to R, it is determined that it is not necessary to transmit alert P, and therefore alert P is not transmitted. Hence, the transmission flag and the transmission completion flag of alert P are both “0”.

Next, alert Q is obtained, and because the unit score of alert Q is 70 (<first threshold value), with regard to alert Q alone, it is determined that it is not necessary to transmit alert Q. However, since the vehicle score of alerts P and Q is 90 (>second threshold value), at this time point it is determined that it is necessary to transmit alerts P and Q. That is, alerts P and Q are transmitted at the same timing. Hence, the transmission flag and the transmission completion flag of alert P are each updated from “0” to “1”. Further, the log transmission ID of alerts P and Q will be a common ID. Alert P at this time is an alert which is related to alert Q and which was not yet transmitted, and is an example of third detection information.

For example, in a case where alert Q was obtained in step S301 shown in FIG. 12 (a case where alert Q is the target alert), in step S305 transmission determiner 113 determines whether or not alert Q and alert P which was obtained from one of the one or more monitoring sensors 120a and the like prior to alert Q (one example of first detection information) and which had not been transmitted at the time point at which the alert Q was obtained are related. If transmission determiner 113 determines that alerts P and Q are related, output unit 117 may transmit alerts P and Q together. That is, output unit 117 may collectively transmit alert P and Q.

Note that, in a case where there is a further alert which is related to alert Q and which was transmitted (one example of second detection information), in step S305, transmission determiner 113 may determine whether or not alert Q and the alert which was transmitted are related to alert P.

Here, it is assumed that alert P had been transmitted before alert Q was obtained, and that the unit score of alert Q is less than the second threshold value. In this case, with respect to alert Q alone, it is determined that it is not necessary to transmit alert Q. However, in a case where the vehicle score of alerts P and Q is greater than or equal to the second threshold value, it is determined that it is necessary to transmit alert Q. That is, a condition for determining that it is necessary to transmit alert Q may be that the vehicle score (one example of the severity of an anomaly) indicated by alerts P and Q is greater than or equal to the second threshold value (one example of a predetermined severity). The aforementioned condition is an example of a predetermined condition. In this case, for example, “1” is set in “severity level” in the vehicle monitoring log information.

Referring again to FIG. 14, subsequently alert R is obtained. The unit score and the vehicle score for alert R are both 100 (>first threshold value and second threshold value). That is, it is determined that it is necessary to transmit alert R. The common log transmission ID of alerts P and Q is set as the preceding log transmission ID of alert R.

By receiving alert R, monitoring system 300 knows that alerts P to R are alerts with respect to a series of attacks, and hence monitoring system 300 can analyze the cyberattack on vehicle 100 based on alerts P to R, without determining whether or not alerts P to R are alerts with respect to a series of attacks.

[2-2. Operations of Monitoring System]

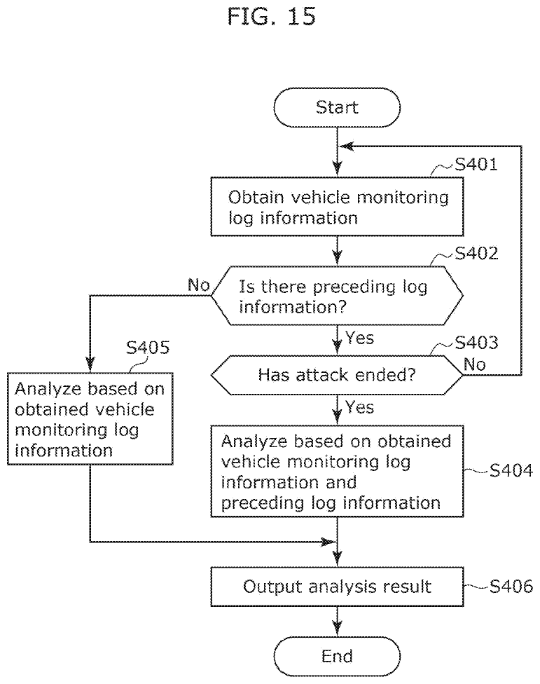

Next, operations of monitoring system 300 will be described while referring to FIG. 15. FIG. 15 is a flowchart illustrating operations of monitoring system 300 according to the present embodiment. Specifically, FIG. 15 is a flowchart illustrating operations of a server configured to include vehicle monitoring log receiver 310 and controller 320. Note that, a case in which alert R shown in FIG. 14 is obtained in step S401 is described supplementarily hereunder as one example.

As illustrated in FIG. 15, vehicle monitoring log receiver 310 of monitoring system 300 obtains vehicle monitoring log information (S401). Vehicle monitoring log receiver 310 receives vehicle monitoring log information including alert R.

Next, controller 320 determines whether or not there is a preceding log transmission ID in the vehicle monitoring log information obtained in step S401 (S402). Controller 320 determines whether or not there is preceding log information by extracting the preceding log transmission ID included in the vehicle monitoring log information that includes alert R. Note that, if the vehicle monitoring log information includes information regarding preceding log existence instead of a preceding log transmission ID, controller 320 can execute the determination in step S402 based on the preceding log existence information. Thus, controller 320 obtains information regarding whether or not preceding log information exists by extracting information included in the vehicle monitoring log information, and without determining whether or not preceding log information exists by processing of its own device.

Next, if there is preceding log information (“Yes” in S402), controller 320 determines whether or not the attack has ended (S403). If information relating to whether or not an attack ended (see FIG. 5 and FIG. 6) is included in the vehicle monitoring log information, controller 320 determines whether or not the attack has ended based on the information. Controller 320 determines whether or not alert R is the final alert caused by a series of attacks.

If the attack has ended (“Yes” in S403), controller 320 analyzes the cyberattack on vehicle 100 based on the obtained vehicle monitoring log information and the preceding log information (S404). That is, controller 320 processes a plurality of alerts (for example, alerts P to R) as alerts belonging to a series of attacks. Further, if the attack has not ended (“No” in S403), controller 320 returns to step S401 and continues the processing.

Further, if there is no preceding log information (“No” in S402), controller 320 analyzes the cyberattack on vehicle 100 based on the obtained vehicle monitoring log information (S405).

Next, controller 320 outputs the result of the analysis in step S404 or S405 (S406). Controller 320, for example, displays the result of the analysis on display 330.

Thus, since monitoring system 300 can obtain information regarding whether or not preceding log information exists from the obtained vehicle monitoring log information, monitoring system 300 need not perform determination processing regarding whether or not preceding log information exists. Hence, even in a case where a plurality of items of log information with respect to a series of attacks are transmitted to monitoring system 300 separately from each other, an increase in the processing load at monitoring system 300 can be suppressed, that is, the processing load at monitoring system 300 can be reduced.

Note that, the determination as to whether or not the attack has ended (S403) may be omitted, and then step S404 may be executed.

### Other Embodiments

Whilst vehicle monitoring system 1 according to one or more aspects has been described above based on an embodiment, the present disclosure is not limited to this embodiment. Other embodiments realized by application of various modifications conceivable by those skilled in the art to the present embodiment, and embodiments configured by combining constituent elements of different embodiments may also be included in the present disclosure as long as the modifications and combinations do not depart from the gist of the present disclosure.

For example, although in the above embodiment an example in which gateway 110 includes transmission determination module 110a is described, the present disclosure is not limited to this example. For example, transmission determination module 110a may be implemented by causing any one of the ECUs provided in vehicle 100 to function as a transmission determination module.

Further, although in the above embodiment an example in which a preceding log transmission ID is included in relevance information is described, a time at which preceding log information was detected may be included instead of a preceding log transmission ID or in addition to a preceding log transmission ID. That is, the relevance information may be information indicating a time at which preceding log information was detected.

Furthermore, although in the above embodiment an example in which a plurality of monitoring sensors 120a and the like are provided in vehicle 100 is described, the present disclosure is not limited to this example, and the number of monitoring sensors 120a provided in vehicle 100 may be one.

Furthermore, although in the above embodiment an example in which transmission determination module 110a is provided in vehicle 100 is described, the present disclosure is not limited to this example. Transmission determination module 110a may be provided in an apparatus that includes one or more devices and is radio-communicably connected to an external device. The apparatus may be, for example, an aerial vehicle such as a drone, or may be a home appliance system that includes one or more household electrical appliances installed in a home or the like.

Further, although in the above embodiment an example in which the respective in-vehicle devices of vehicle 100 communicate by wire communication is described, the present disclosure is not limited to this example, and communication by radio communication may be carried out between at least some of the devices.

In addition, the separation of the functional blocks in the block diagrams is an example, and multiple functional blocks may be implemented as a single functional block, a single functional block may be separated into multiple functional blocks, or some of the functions of a functional block may be transferred to a different functional block. For example, monitoring log storage 112 and transmission status storage 114 may be implemented by a single storage device or may be implemented by three or more storage devices. Further, monitoring system 300 need not have display 330 and operation unit 340. For example, display 330 and operation unit 340 may be installed at a different location to the monitoring center and communicably connected to monitoring system 300. Further, the functions of a plurality of functional blocks having similar functions may be processed, in parallel or by time-sharing, by single hardware or software.

Further, the sequence in which the respective steps in the flowcharts are executed is given as an example for describing the present disclosure in specific terms, and thus sequences other than the above are possible. Furthermore, part of the above-described steps may be executed simultaneously (in parallel) with another step.

Further, some or all of the constituent elements included in transmission determination module 110a and monitoring system 300 in the embodiment described above may be constituted by a single system LSI (Large Scale Integration).

The system LSI is a super-multifunctional LSI manufactured by integrating a plurality of processing units on one chip, and is specifically a computer system configured to include a microprocessor, a ROM (read only memory), a RAM (random access memory), and so forth. A computer program is stored in the ROM. The microprocessor operates in accordance with the computer program, thereby allowing the system LSI to achieve its function. Note that, all or some of the various processing described above may be implemented by hardware such as an electronic circuit.

Furthermore, an aspect of the present disclosure may be a computer program that causes a computer to execute each characteristic step included in a method for controlling transmission determination module 110a and monitoring system 300. Furthermore, an aspect of the present disclosure may be a non-transitory computer-readable recording medium on which such a program is recorded. For example, such a program may be recorded to a recording medium and distributed or circulated. For example, installing a distributed program in another device having a processor, and causing the processor to execute the program makes it possible to cause the device to perform the respective processing operations described above.

While various embodiments have been described herein above, it is to be appreciated that various changes in form and detail may be made without departing from the spirit and scope of the present disclosure as presently or hereafter claimed.

### FURTHER INFORMATION ABOUT TECHNICAL BACKGROUND TO THIS APPLICATION

The disclosures of the following patent application including specification, drawings and claims are incorporated herein by reference in their entirety: Japanese Patent Application No. 2020-163044 filed on Sep. 29, 2020.

### INDUSTRIAL APPLICABILITY

The present disclosure is useful in a system that monitors object which are capable of communication with an external device through a communication network.

1. An information transmission device that is provided in an object, the object including one or more devices and a monitoring sensor monitoring each of the one or more devices, the information transmission device comprising:
an obtainer that obtains, from the monitoring sensor, first detection information indicating that an anomaly is detected in any one of the one or more devices;
a transmitter that transmits, to an external device, monitoring information including (i) the first detection information and (ii) relevance information,
the relevance information indicating relevance between the first detection information and second detection information which is obtained from the monitoring sensor and transmitted from the transmitter to the external device prior to the transmission of the first detection information,
the second detection information indicating that an anomaly is detected in any one of the one or more devices, and relating to the first detection information.

2. The information transmission device according to claim 1, wherein
the relevance information includes at least one of:
information indicating that the second detection information is present; or
information which is for identifying the second detection information and is included in the second detection information.

3. The information transmission device according to claim 1, wherein
the transmitter transmits the monitoring information when a predetermined condition is satisfied,
the monitoring information further includes information indicating that the predetermined condition is satisfied.

4. The information transmission device according to claim 3, further comprising:
a storage that holds the first detection information, wherein
the predetermined condition includes at least one of:
a condition that a severity of the anomaly indicated in the first detection information is greater than or equal to a predetermined severity;
a condition that a cyberattack causing the anomaly is determined to have ended;
a condition that a predetermined time period has passed since the anomaly indicated in the first detection information is detected; or
a condition that an available capacity of the storage is less than or equal to a predetermined capacity.

5. The information transmission device according to claim 4, wherein
the predetermined condition further includes a condition that each of a severity of the anomaly indicated in the first detection information and a severity of the anomaly indicated in the second detection information is greater than or equal to the predetermined severity.

6. The information transmission device according to claim 1, further comprising:
a first determiner that determines whether or not the second detection information is related to the first detection information, based on (i) respective times of obtaining the first detection information and the second detection information by the obtainer or (ii) a time sequential pattern regarding the anomalies indicated in the first detection information and the second detection information, the time sequential pattern being at least one of (ii-1) a time sequential pattern of devices from which the anomalies are detected among the one or more devices or (ii-2) a time sequential pattern of types of the anomalies.

7. The information transmission device according to claim 6, wherein
when the obtainer obtains the first detection information within a predetermined time period after the obtainer obtains the second detected information, or
when the time sequential pattern regarding the anomalies indicated in the first detection information and the second detection information at least partially matches a predetermined time sequential pattern,
the first determiner determines that the second information is related to the first detection information.

8. The information transmission device according to claim 6, wherein
the first determiner determines whether or not third detection information is related to the first detection information, the third detection information being obtained by the obtainer from the monitoring sensor prior to the obtaining of the first detection information, and not having yet been transmitted from the transmitter to the external device at a time of the obtaining of the first detection information, and
the transmitter transmits the third detection information together with the first detection information to the external device, when the first determiner determines that the third detection information is related to the first detection information and the second detection information.

9. The information transmission device according to claim 1, wherein
the object is a vehicle, and
the one or more devices and the information transmission device are included in an in-vehicle network by connection via a communication path.

10. The information transmission device according to claim 4, wherein
the severity includes a unit score indicating a level of a threat to the first detection information,
the predetermined condition includes a condition that the unit score is greater than or equal to a first threshold value, and
the information transmission device further comprises
a second determiner that determines whether or not to transmit the first detection information, by determining whether or not the unit score regarding the first detection information satisfies the predetermined condition.

11. The information transmission device according to claim 10, wherein
the second determiner:
determines whether or not third detection information related to the first detection information is present, when the second determiner determines that the unit score regarding the first detection information is smaller than the first threshold value;
calculates, based on the first detection information and the third detection information, an object score indicating an overall thread to the object, when the second determiner determines that the third detection information is present; and
performing, in accordance with the object score calculated, the determining as to whether or not to transmit the first detection information.

12. The information transmission device according to claim 11, wherein
the second determiner determines whether or not the object score based on the first detection information and the third detection information is greater than or equal to a second threshold value, and
when the object score based on the first detection information and the third detection information is greater than or equal to the second threshold value, the second determiner determines that the first detection information is to be transmitted.

13. The information transmission device according to claim 11, wherein
the third detection information is obtained from the monitoring sensor prior to the obtaining of the first detection information, and the third detection information is not yet transmitted at a time when the first detection information is obtained in accordance with a result of the determination, the determination being made by the second determiner and in accordance with the unit score regarding the third detection information,
the second determiner (i) updates, in accordance with the object score based on the first detection information and the third detection information, the object score based on the third detection information, and (ii) performs again, in accordance with the object score updated, the determination as to whether or not to transmit the third detection information.

14. The information transmission device according to claim 13, wherein
the second determiner replaces the object score based on the third detection information by the object score based on the first detection information and the third detection information.

15. The information transmission device according to claim 13, wherein
the second determiner prioritizes a second determination result over a first determination result,
the first determination result being a result of determining whether or not to transmit the third detection information, in accordance with the unit score regarding the third detection information,
the second determination result being a result of determining whether or not to transmit the third detection information, in accordance with the object score regarding the third detection information.

16. A server, comprising:
a receiver that receives the first detection information from the information transmission device according to claim 1; and
a controller that analyzes a cyberattack on the object in accordance with the first detection information and the second detection information, the second detection information being indicated in the relevance information included in the first detection information and being received by the receiver prior to the receiving of the first detection information.

17. The server according to claim 16, wherein
the controller determines, based on the relevance information included in the first detection information, whether or not the second detection information is related to the first detection information.

18. The server according to claim 17, wherein
the first detection information includes attack end information indicating whether or not a cyberattack to the object is determined to have ended,
when the controller determines that the second detection information is related to the first detection information, the controller further determines, based on the attack end information, whether or not the cyberattack to the object is determined to have ended, and performs the analyzing in accordance with a result of the further determining.

19. The server according to claim 18, wherein
when the controller determines that the cyberattack to the object has been ended, the controller performs the analyzing based on the first detection information and the second detection information, and
when the controller determines that the cyberattack to the object has not yet been ended, the controller does not perform the analyzing.

20. An information transmission method for an object, the object including one or more devices and a monitoring sensor monitoring each of the one or more devices, the information transmission method comprising:
obtaining, from the monitoring sensor, first detection information indicating that an anomaly is detected in any one of the one or more devices;
transmitting, to an external device, monitoring information including (i) the first detection information and (ii) relevance information,
the relevance information indicating relevance between the first detection information and second detection information which is obtained from the monitoring sensor and transmitted from the transmitter to the external device prior to the transmission of the first detection information,
the second detection information indicating that an anomaly is detected in any one of the one or more devices, and relating to the first detection information.
